(19) United States
(12) Patent Application Publication
(10) Pub. No.: US 2019/0327898 A1
(43) Pub. Date: Oct. 31, 2019

(54) HAYMAKING MACHINE HAVING ROTORS PROVIDED WITH SECURED TOOLS

(71) Applicant: KUHN S.A., Saverne (FR)

(72) Inventor: Emmanuel DAUTREMONT, Berg (FR)

(73) Assignee: KUHN S.A., Saverne (FR)

(21) Appl. No.: 16/394,110

(22) Filed: Apr. 25, 2019

(30) Foreign Application Priority Data
Apr. 26, 2018 (FR) 18 53653

(51) Int. Cl. A01D 80/02; A01D 78/00

(52) U.S. Cl. CPC A01D 80/02; A01D 78/006

(57) ABSTRACT

A haymaking machine having rotors provided with secured tools, which machine includes at least one rotor having at least one radially extensible rotary support arm, with an inner end connected to the rotor hub and an opposite outer end carrying at least one working tool possessing spikes connected by an intermediate portion presenting coils on the one hand and at least one angled section for fixation to the support arm on the other hand, the arm extends internally through at least some of the coils and a piece for retaining the coils and not coupled with the support arm is attached to this latter. The retaining piece integrates at least one part of the one or more means for fixation of the working tool on the support arm.

The present invention relates to the field of agricultural machinery and concerns a haymaking machine having improved protective means.

The invention is directed more particularly at a haymaking machine comprising at least one rotor having at least one radially extensible rotary support arm, with an inner end connected to the rotor hub and an opposite outer end carrying at least one working tool possessing spikes connected by an intermediate portion presenting coils on the one hand and at least one angled section for fixation to the support arm on the other hand, wherein this arm extends internally through at least some of the coils, and wherein attached to or mounted on the support arm (but not integrally formed with the support arm) is provided a piece for retaining the coils (i.e., to keep the coils from falling) should the coils become detached from the support arm.

The rotors are typically mounted in aligned manner on a rolling chassis. The two spikes, the coils and the angled part for fixation of each working tool are generally formed from a single segment of steel wire conformed to constitute the tool.

To ensure that the forage—or plants—displaced by the spikes does not come into contact with the coils and does not reduce their deformability, it has been proposed to install protective caps, as described in documents DE 1 482 174 and EP 1 929 857, which more generally disclose examples of haymaking machines of the type in question.

Nevertheless, this type of machine is exposed to a clearly greater safety risk factor. In fact, during operation, the spikes may be subjected to large forces due to the advance of the machine, for example, or when a working tool encounters a large obstacle such as a boundary post or a large partly buried rock, and the coils close to the outer spike (which is the most stressed) are then subjected to large deformations that may lead to a rupture in their region. In this case, the coils situated near the exterior beyond the rupture point become detached from the arm, as does the corresponding outer spike. Such a detached spike is dangerous if it is ejected into the air. In addition, it may be lost in the forage and cause considerable damage if it were to pass into a baler or silage harvester being used for the harvest.

In the aforesaid document EP 1 929 857, the Applicant already proposed a solution for preventing ejection and loss of such a detached part of a broken working tool, while at the same time achieving protection of the coils from the displaced forage.

Nevertheless, the piece assuring the aforesaid double function is of complex construction and, above all, its fixation by way of a bolt, which at the same time ensures that the working tool is made integral with the support arm, is tedious and time-consuming for the fitter.

From documents EP 3 132 668 and FR 3 006 553, haymaking machines of the aforesaid type are further known in which the function of retention of a detached part of a broken tool on the support arm is assured by a piece in the form of a bolt provided with an elongated primary part nested in the end of the support arm and a secondary part having a collar, the outside diameter of which is larger than the inside diameter of the coils.

Nevertheless, the implementation of these solutions necessarily requires an end of the support arm that is hollow, and its mounting with a bolt is also tedious.

Another known solution proposes retention in the region of the spikes and not of the coils, by making them integral with one another, which limits the flexibility of the tool.

Finally, solutions also exist in which the working tool is fixed not directly on the support arm (which does not pass through the coils), but on an accessory piece of complex shape that is fixed on the support arm. The resulting construction is complex and costly, and the complicated assembly of multiple pieces is tedious.

The objective of the invention is to propose a simple and less costly constructive solution, which permits retention of the detached part of a broken working tool on the support arm and which can be implemented with a solid or hollow support arm, wherein the number of pieces is reduced and its assembly is facilitated. In addition, it should be possible to combine this solution easily with the realization or the fixation of a protective cap.

To this end, the invention has as its object a haymaking machine comprising at least one rotor having at least one radially extensible rotary support arm, with an inner end connected to the rotor hub and an opposite outer end carrying at least one working tool possessing spikes connected by an intermediate portion presenting coils on the one hand and at least one angled section for fixation to the support arm on the other hand, wherein this arm extends internally through at least some of the coils, and wherein attached to or mounted on the support arm (but not integrally formed with the support arm) is provided a piece for retaining the coils (i.e., to keep the coils from falling) should the coils become detached from the support arm,

which machine is characterized in that the said retaining piece integrates at least one part of the one or more means for fixation of the working tool in question on the support arm.

The invention will be better understood by virtue of the description hereinafter, which relates to preferred embodiments, provided by way of non-limitative examples and explained with reference to the attached schematic drawings, wherein:

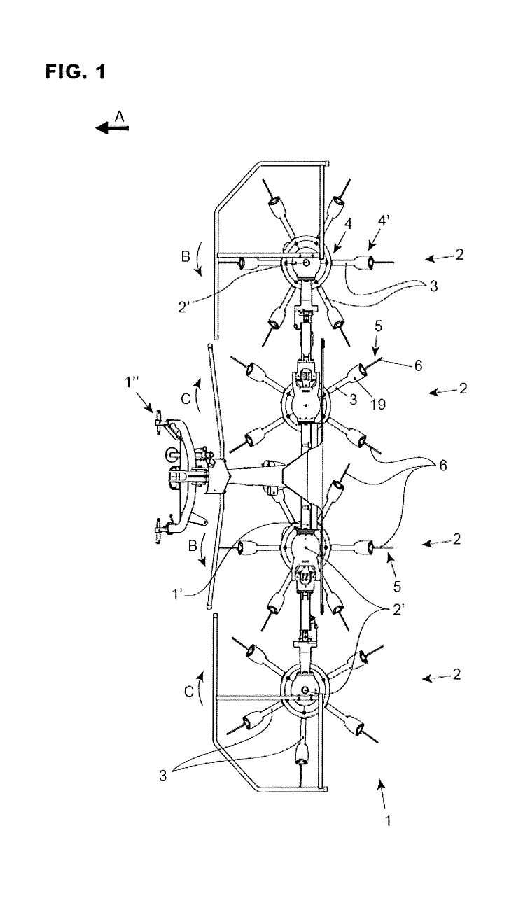

FIG. 1 is an overhead representation of an example of a haymaking machine, of the tedder type, according to the invention;

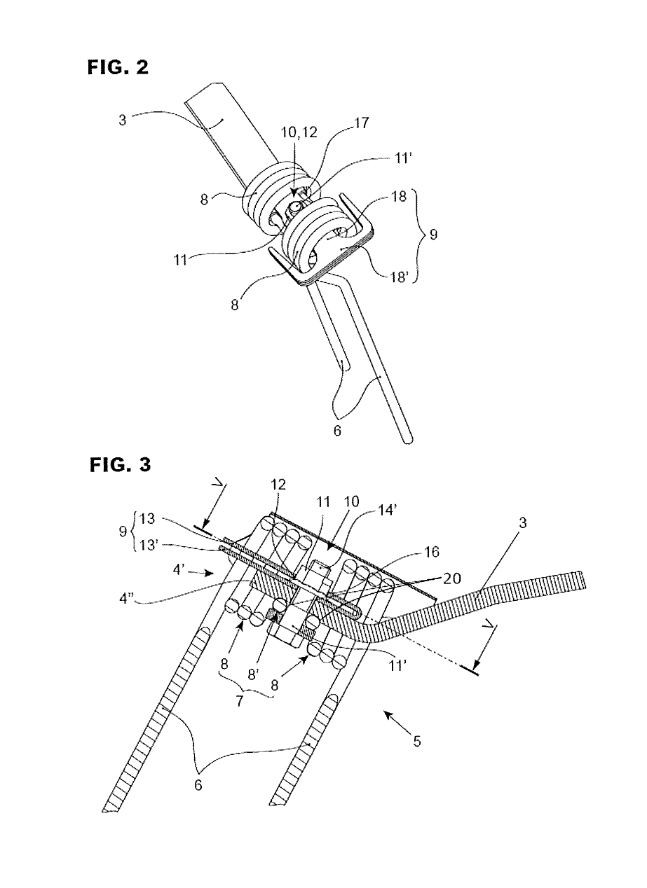

FIG. 2 is a perspective view of a support arm equipped with a working tool (with cap removed) forming part of a rotor of a haymaking machine according to the invention;

FIG. 3 is a partial view on a different scale and in section through a plane containing the axis of the fixation bolt and the central axis of the outer end portion of a support arm provided with a working tool such as represented in FIG. 2 (provided with a protective cap), according to a first embodiment of the invention;

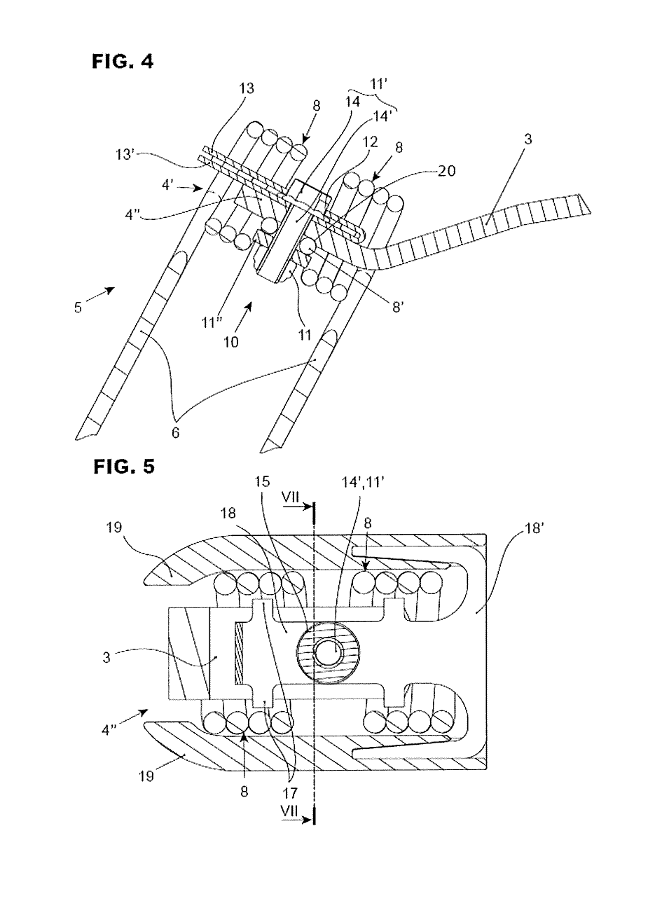

FIG. 4 is a view similar to that of FIG. 3 of a constructive variant of the first embodiment of the invention (cap removed from the tool);

FIG. 5 is an overhead view in section according to V-V of the object represented in FIG. 3;

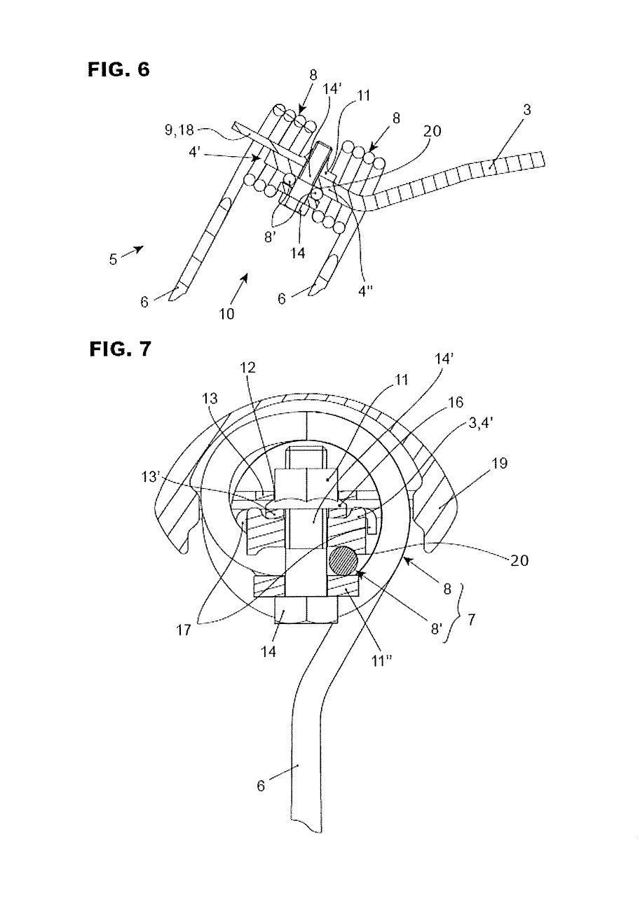

FIG. 6 is a view similar to that of FIG. 3 of a second embodiment of the invention (cap removed from the tool);

FIG. 7 is a view in section according to VII-VII of the object of FIG. 5, and

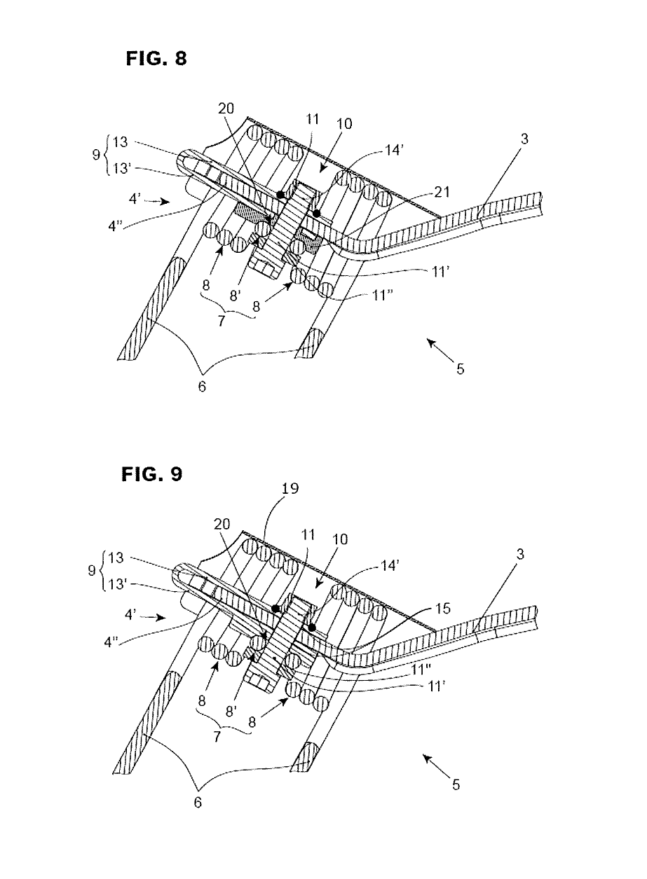

FIGS. 8 and 9 are views in section similar to those of FIGS. 3, 4 and 6, illustrating two constructive variants of a third embodiment of the invention.

As FIG. 1 shows by way of illustrative example, a haymaking machine 1 of the tedder or rotary plant spreader type typically comprises a chassis 1′ integral with a hitch support 1″, preferentially of the three-point type, for attachment to a tractor or the like. Chassis 1′ may be equipped with wheels and/or may be carried by the tractor in the transport position of machine 1.

Chassis 1′ has substantially the form of a linear segmented structure, which is foldable section-by-section and extends, during use of machine 1, perpendicular to direction of advance A. The different segments are articulated to one another, on the one hand for folding of chassis 1′ in the direction of hitch support 1″ (transport position). On the other hand, the articulation of the segments of chassis 1′ permits machine 1 to adapt its shape to the contours of the terrain, improving how it follows the irregularities of the soil and thus also the quality of raking as well as the neatness of the plants being spread. FIG. 1 shows machine 1 in the state deployed for use (working position).

Chassis 1′ carries a certain number of rotors 2, each constituted by several radial arms 3 arranged around a hub 2′, which defines, for the rotor 2 in question, an axis of rotation having an orientation that is vertical or slightly inclined, preferably toward the front (direction of advance during use). These rotors 2, which are present in even numbers and may have opposite directions of rotation in pairs (see directions of rotation B and C in FIG. 1) to displace the plants, preferably toward the rear in order to turn them over and distribute them on the soil, are driven in rotation by the power take-off of the tractor or the like. In one specific mode of operation and/or according to one specific configuration of machine 1, rotors 2 may be driven in such a way as to constitute windrows. In addition, each rotor 2 is equipped with one or more support ground support castors (not shown in FIG. 1), advantageously mounted idly.

A working tool 5 having projecting spikes 6, thus forming a tine (preferentially two tines), is fixed at the radially outer end 4′ of each arm 3.

During the rotation and displacement of a rotor 2, tools 5 together with spikes 6 rake the soil to raise and displace cut and bulk plants, such as grass or straw, in view of turning them over and dispersing them or of collecting them in windrows (as a function of the setting of machine 1).

As is evident more clearly in FIGS. 2 to 7, haymaking machine 1 according to the invention comprises at least one rotor 2 having at least one radially extensible rotary support arm 3, with an inner end 4 connected to the hub 2′ of rotor 2 and an opposite outer end 4′ carrying at least one working tool 5 possessing spikes 6 connected by an intermediate portion 7. This portion 7 presents coils 8 on the one hand and at least one angled section 8′ for fixation to the support arm 3 on the other hand, wherein this arm 3 extends internally through at least some of the coils 8, and wherein attached to or mounted on the support arm (but not integrally formed with the support arm) is provided a piece 9 for retaining the coils 8 (i.e., to keep the coils from falling) should the coils become detached from the support arm.

According to the invention, and as shown in FIGS. 3 to 9, the said retaining piece 9 integrates at least one part of the one or more means 10 for fixation of the working tool 5 in question on support arm 3.

By virtue of this technical arrangement, the invention makes it possible to reduce the number of separate pieces to be implemented for assembly of working tool 5 with support arm 3, permits retaining piece 9 and working tool 5 to be made simultaneously integral with support arm 3 and above all makes the operation of mounting and assembly of these elements 5 and 9 easier and less tedious.

When the or each fixation means 10 is constituted, for example, of two components mutually cooperating to ensure the function of connecting or of being made integral, it may be provided that one of these two components or at the very least the functional part for connecting the one of these two components or making it integral is integrated or incorporated in retaining piece 9.

Advantageously, the said retaining piece 9 blocks one of the components 11 or 11′ of the one or more fixation means 10 in question from rotation or incorporates it rigidly in one-piece or attached manner.

In entirely preferred manner, the one or more fixation means 10 consists of a bolt and the said retaining piece 9 integrates a thread of one of the two components 11 and 11′ of the said or of each bolt 10, i.e. of the nut 11 or of the screw 11′.

In relation with this type of fixation means in two parts screwed one into the other and furnishing a rigid and resistant mechanical assembly, which is easily demountable and can be made with appropriate tightening, the invention avoids having to hold one of the components 11, 11′ in addition to retaining piece 9.

Preferentially, each bolt 10 also comprises a support washer 11″ and a single bolt 10 is provided for each tool 5.

According to a first preferred embodiment of the invention, shown by way of example in FIGS. 2 to 5 and 7, the screw 1′ or nut 11 of the or each bolt 10 integrated into retaining piece 9 is a separate element held and retained in a notch 12 of the said retaining piece 9.

In this embodiment, it is possible to use a standard piece for the or each bolt 10 (less cumbersome) while also arranging a rigid fixation by virtue of an appropriate thread, i.e. of length and diameter adapted to the forces potentially necessary for this fixation. FIGS. 3 and 4 illustrate two variants of this embodiment with confinement either of the nut (FIG. 3) or of the screw (FIG. 4), in captive manner (pre-mounting of screw 11′ or of nut 11 in or on retaining piece 9).

Nut 11 or the head of screw 11′ thus does not have any degree of freedom relative to piece 9. The confinement of nut 11 or of the head of screw 11′ relative to all degrees of freedom makes it possible to prevent loss of the nut without having to hold or retain it, thus facilitating even more the assembly of bolt 10 under consideration (by manipulation of the screw alone).

Screw 11′ or nut 11 is blocked from rotation in, preferably by, retaining piece 9, and preferably around the axis of bolt 10.

Advantageously, screw 11′ or nut 11 is blocked from rotation around the axis of bolt 10 in notch 12, preferably by notch 12 itself. Thus it is merely necessary to position the two components 11 and 11′ to be screwed together in mutually facing manner, wherein retaining piece 9 thus serves as holding piece for one of the two components.

This blocking of one of the components 11′ or 11 from rotation has the consequence that the assembly of bolt 10 necessitates only the manipulation of the other component 11 or 11′ of the said bolt 10.

Preferentially, a single bolt 10 is provided for the fixation of each working tool 5.

In accordance with a very advantageous variant of this first embodiment of the invention, illustrated in FIGS. 3 to 7, retaining piece 9 is attached externally to one face of an outer end portion 4″ of support arm 3, preferentially having a solid structure.

According to a practical construction of this variant, piece 9 may comprise two walls 13, 13′, one 13 of which is provided with a notch 12 forming a recess for holding nut 11 or the head 14 of screw 11′ and blocking it from rotation and the other 13′ of which is provided with an orifice 15 for passage of the shank 14′ of screw 11′, wherein nut 11 or the head of screw 14 is confined between these two walls 13 and 13′, preferentially with a slight play.

According to a characteristic of the invention consistent with the aforesaid construction, nut 11 or the head of screw 14 may be provided with a radial collar or shoulder 16, the diameter of which is at least slightly larger than both notch 12 and orifice 15 for passage of shank 14′ of screw 11′. By this it will be understood that the diameter of the radial collar or shoulder 16 is at least slightly larger than the width of notch 12 and than the width or diameter of orifice 15 for passage of shank 14′ of screw 11′.

Thus component 11 or 11′ is incorporated in captive manner in retaining piece 9 by mechanical assembly and is held in relatively fixed manner in the retaining piece 9.

According to a second embodiment of the invention, represented in particular in FIG. 6, component 11, 11′ of the or each bolt 10, which is integrated into retaining piece 9, is made rigidly integral (for example by welding) or made in one piece with the said retaining piece 9.

Thus retaining piece 9 may constitute screw 11′ or nut 11 of bolt 10 and, according to this embodiment, retaining piece 9 incorporates one of the constituent and mutually cooperating components 11 or 11′ of the one or more fixation means 10 in question.

Retaining piece 9 may incorporate one of the components 11 or 11′ by making them in one piece. The piece made in one piece may be realized, for example, by a female thread, preferably preceded by flow drilling. Alternatively, one of the components 11 or 11′ may be assembled in rigid and non-demountable manner with piece 9, for example by adhesive bonding or welding.

In this case, the production of retaining piece 9 makes it possible to incorporate the thread immediately.

In accordance with an advantageous characteristic of the invention, and as shown in FIGS. 3, 4 and 5 to 9, angled section 8′ of intermediate position 7 of working tool 5 under consideration is made integral with outer end portion 4″ of support arm 3 by jamming, with tightening by fixation means 10, one part at least of the said angled section 8′, in a manner received with shape cooperation, into a cavity or indentation 20 formed in the said end portion 4″, into a component 11, 11′ of fixation means 10 or into an intermediate adapter piece 21 mounted between the said section 8′ and the said portion 4″.

The cavity or indentation 20 that is present in one of the pieces 4″, 11, 11′ or 21 in direct contact with the said angled section 8′ and that ensures that it is made integral and held rigidly by pinching, takes advantage of at least one surface portion embracing the rounded external shape (viewed in section) of the said angled section 8 and thus makes it possible to provide a zone of contact enhanced by shape cooperation, thus ensuring better fixation and a better fit.

FIGS. 3 to 9 illustrate different constructive variants for realizing fixation by jamming with tightening.

Thus the cavity or indentation 20 may be made (by machining, for example) directly in arm 3 (at the position of portion 4″), as shown in FIGS. 3, 4, 6 and 7.

According to another variant, not illustrated but easily inferred from the aforesaid figures, this cavity or this indentation 20 may also be formed in nut 11 or in the head of screw 14 of bolt 10.

When an intermediate adapter piece 21 is present, it is the intermediate adapter piece 21 that advantageously has the said cavity or the said indentation 20 (see FIGS. 8 and 9).

According to a third embodiment of the invention, shown in the said FIGS. 8 and 9, retaining piece 9 may comprise two walls 13 and 13′, extending on both sides of outer end portion 4″ of support arm 3, by sandwiching this portion between them, preferentially with elastic pinching, even in the absence of tightening, wherein these walls 13 and 13′ cooperate with the two components 11 and 11′ of fixation means 10 and with intermediate adapter piece 21 to make retaining piece 9 and angled section 8′ integral with end portion 4″.

It may then be provided that one of the walls 13 and 13′ of retaining piece 9 carries or integrates component 11 forming the nut of fixation means 10 and that the other wall, situated on the opposite side of outer end portion 4″, carries or integrates intermediate adapter piece 21.

Thus nut 11 may be welded onto the wall 13 under consideration or be formed as an integral part of this wall 13 (screw 11′ passes through end portion 4″, the two walls 13 and 13′ that frame it and adapter piece 21 at the position of traversing and coinciding orifices).

Adapter piece 21 may consist of a separate piece attached to wall 13′ and made integral with the wall 13′ by, for example, assembly with mechanical engagement locked by welding, adhesive bonding or crimping (FIG. 8).

As a variant, adapter piece 21 may also be made in one piece with retaining piece 9 and may constitute a part of wall 13′ (FIG. 9), wherein cavity or indentation 20 is then formed in this piece 9.

An advantage of this third embodiment is that arm 3 is jammed by retaining piece 9. In this way, retaining piece 9 is advantageously retained by jamming on arm 3 (even when shank 14′ of screw 11′ is not engaged in orifices 15 or of arm 3), which also facilitates mounting. In addition, it is simpler and less cumbersome to realize machining on a piece of small caliber, such as retaining piece 9 or respectively adapter piece 21, than in a voluminous piece such as arm 3.

In this third embodiment also, as for the embodiment of FIG. 6, nut 11 may be formed in one piece or attached with rigid fixation at the position of wall 13 of piece 9.

To facilitate, even more, the mounting of retaining piece 9 and of component 11, 11′ of the bolt integrated here, and also to be able to ensure pre-alignment of retaining piece 9 with end portion 4″ of support arm 3 on which it must be fixed, the said retaining piece 9 may comprise a guide means 17 that prevents its rotation relative to support arm 3 around the axis of bolt 10, wherein the said guide means 17 advantageously comprises at least one foot or one wing (see FIGS. 2 and 5, for example). This guide means 17 may also facilitate the alignment between piece 9 and arm 3 during mounting.

One or more pair(s) of opposite feet 17 may effectively ensure the aforesaid alignment and blocking between piece 9 and support arm 3.

According to an advantageous practical construction shown in the attached drawings, retaining piece 9 is constituted by a first part 18 for making it integral with support arm 3, extending into coils 8 and integrating one part 11, 11′ of the means 10 for fixation of working tool 5, and by a second retaining part 18′, extending beyond the last outer coil and having a transverse dimension greater than the inside diameter of coils 8.

According to a first constructive variant shown especially in FIGS. 2 to 7, retaining piece 9 has a flat and planar general shape, double-walled as the case may be, in the form of a T or double hook.

According to another constructive variant, the retaining piece may also form cap 19 for protection and external covering, at least partly, of coils 8 of working tool 5.

Advantageously, cap 19 is then constituted by an extension in one piece of second part 18′ of retaining piece 9, wherein the said cap 19 may be connected if necessary to support arm 3 at one second point at least.

The constitution of retaining piece 9 may then be related to that described and represented in the aforesaid document EP 1 929 857.

As a variant, and as shown in FIG. 5, such a cap 19 may also be a separate piece fixed on the support arm 3 in question, possibly at least partly by way of retaining piece 9, on which it may be nested, for example.

Although retaining piece 9 is advantageously made of metal, cap 19 in turn may be a piece of plastic material when it is attached separately.

Of course, the invention is not limited to the embodiments described and represented in the attached drawings. Modifications are still possible especially from the viewpoint of the constitution of the various elements or by substitution of equivalent techniques, without departing from the scope of protection of the invention.

1: A haymaking machine comprising:
at least one rotor including at least one radially extensible rotary support arm, an inner end of the support arm being connected to a hub of the rotor and an opposite outer end of the support arm including at least one working tool, the at least one working tool including spikes being connected by an intermediate portion, the intermediate portion including coils on one end and at least one angled section for fixation to the support arm on an opposite end, the support arm extending internally through at least a part of the coils, and a coils retaining piece not coupled with the support arm being is mounted on this latter,
wherein the coils retaining piece integrates at least a part of at least one fixation means for fixing the at least one working tool on the support arm.

2: A machine according to claim 1, wherein the at least one fixation means includes a bolt including two components, and the coils retaining piece integrates a thread of one of the two components of the bolt, the two components of the bolt including a nut and a screw.

3: A machine according to claim 2, wherein the screw or the nut integrated into the coils retaining piece is a separate element held and retained in a notch of the coils retaining piece.

4: A machine according to claim 3, wherein the screw or the nut is blocked from rotation around an axis of the bolt in the notch.

5: A machine according to claim 2, wherein the coils retaining piece is attached externally to the outer end portion of the support arm and includes two walls, one of the two walls including a notch forming a recess for holding the nut or a screw head of the screw and blocking the bolt from rotation, and the other of the two walls including an orifice for passage of a shank of the screw, wherein the nut or the screw head is confined between the two walls.

6: A machine according to claim 5, wherein the nut or the screw head includes a radial collar or a shoulder, a diameter being at least larger than both the notch and the orifice for passage of the shank of the screw.

7: A machine according to claim 2, wherein the component of the bolt integrated into the retaining piece is one piece or is made rigidly integral with the coil retaining piece.

8: A machine according to claim 1, wherein the angled section of the intermediate position of the at least one working tool is configured to integrate with the outer end portion of the support arm by jamming, with a tightening by the at least one fixation means, at least a part of the angled section, in a manner received with shape cooperation, into a cavity or an indentation formed in the outer end portion, into a component of the at least one fixation means or into an intermediate adapter piece mounted between the angled section and the outer end portion.

9: A machine according to claim 7, wherein the coils retaining piece includes two walls extending on both sides of the outer end portion of the support arm and sandwiching the outer end portion between the two walls, wherein the two walls cooperate with the two components of the at least one fixation means and with the intermediate adapter piece and integrate the coils retaining piece and the angled section with the outer end portion.

10: A machine according to claim 9, wherein one of the two walls includes or integrates the component forming the nut of the at least one fixation means, and the other wall of the two walls, located on an opposite side of the outer end portion, includes or integrates the intermediate adapter piece.

11: A machine according to claim 2, wherein the coils retaining piece includes a guide means preventing a rotation relative to the support arm around an axis of the bolt, the guide means including at least one foot or one wing.

12: A machine according to claim 1, wherein the coils retaining piece includes a first part configured to integrate with the support arm, and a second part, the first part extending into the coils and integrating one part of the at least one fixation means of the at least one working tool, and the second part extending beyond a last outer coil and including a transverse dimension greater than an inside diameter of the coils.

13: A machine according to claim 1, wherein the coils retaining piece forms a cap for protection and external covering, at least partly, of the coils of the at least one working tool.

14: A machine according to claim 9, wherein the two walls are sandwiching the outer end portion between the two walls with elastic pinching.
